(19) United States
(12) Patent Application Publication
(10) Pub. No.: US 2024/0278624 A1
(43) Pub. Date: Aug. 22, 2024

(54) DRAIN GROMMET

(71) Applicant: Hanon Systems, Daejeon (KR)

(72) Inventors: Hyung Joo KIM, Daejeon (KR); Hong Hee JEONG, Daejeon (KR); Yong Heung LEE, Daejeon (KR); Jung Jae LEE, Daejeon (KR); Beom Ki KIM, Daejeon (KR)

(21) Appl. No.: 18/287,896

(22) PCT Filed: Nov. 7, 2022
(86) PCT No.: PCT/KR2022/017322

§ 371 Date: Oct. 23, 2023

(30) Foreign Application Priority Data
Nov. 8, 2021 (KR) 10-2021-0152169
Oct. 6, 2022 (KR) 10-2022-0127514

(51) Int. Cl. B60H 1/32; F16L 5/02

(52) U.S. Cl. CPC B60H 1/3233; F16L 5/02

(57) ABSTRACT

The present invention relates to a drain grommet. The drain grommet, according to one embodiment of the present invention, which is coupled to a vehicle body panel while a drain hose is inserted and fixed therein, comprises: a grommet body having a through-hole into which the drain hose is inserted; and a first stopping part which protrudes from the outer peripheral surface of the grommet body, and which is caught on one surface of the vehicle body panel, wherein the grommet body can have a tension groove on the inner peripheral surface thereof so as to be elastically deformed inward when coupled to the vehicle body panel while the drain hose is inserted and fixed thereto.

### TECHNICAL FIELD

The present invention relates to a drain grommet, and more specifically, to a drain grommet for coupling a drain hose to a vehicle body panel.

### BACKGROUND ART

In general, key components of a vehicle air conditioner include a compressor, a condenser, an expansion valve, and an evaporator. In addition, the vehicle air conditioner includes a blower which blows hot air into the evaporator and returns cooled air in the evaporator to an interior of a vehicle, various connecting hoses or piping members which connect the components, and case components of a heating/ventilating/air conditioning (HVAC) system which is a closed system formed by assembling the components.

In such an air conditioner, when the compressor adiabatically compresses a heated refrigerant gas, the refrigerant gas is compressed and liquefied through the condenser. As the liquefied refrigerant adiabatically expands in an expansion valve toward the inside of the evaporator, heat exchange actively occurs on a surface of the evaporator. In this case, hot air comes into contact with the surface of the evaporator and cold air comes into contact with the inside of the evaporator to exchange heat, and thus cooled air and condensate water are generated. In addition, the cooled air is blown into the interior of the vehicle by the blower, and the condensate water is discharged to the outside of the vehicle through a drain hose unit.

As described above, a drain hose and a drain grommet fixedly fitted onto an outer circumferential portion of the drain hose are used to discharge the condensate water, which is generated when the vehicle air conditioner is operated, to the outside of the vehicle.

However, when the drain hose and the grommet are fixedly assembled to a vehicle body in the vehicle, in a case in which an outer diameter of the drain hose is equal to an inner diameter of the grommet, there is a problem that it is difficult to assemble the vehicle body in the case of interior assembly, worker's dissatisfaction increases, and thus productivity decreases.

In order to solve such problems, oil is applied to improve assemblability, but there is a problem of increasing a cost.

### DISCLOSURE

### Technical Problem

One embodiment is directed to providing a drain grommet capable of improving assemblability of a drain grommet to a vehicle body and preventing worker's dissatisfaction to improve productivity.

In addition, one embodiment is directed to providing a drain grommet of which an increase in cost due to an oil coating method used for improving assemblability of a vehicle body is reduced because of not using the method.

In addition, one embodiment is directed to providing a drain grommet having a two-stage hook structure to increase a fixing force when fixed to a drain hose.

Objectives to be solved by the present invention are not limited to the above-described objectives, and the other objectives which are not described above will be clearly understood by those skilled in the art from the following description.

### Technical Solution

One aspect of the present invention provides a drain grommet coupled to a vehicle body panel in a state in which a drain hose is fixedly inserted into the drain grommet, the drain grommet including a grommet body provided with a through hole into which the drain hose is inserted, and a first stopping part which is provided to protrude from an outer circumferential surface of the grommet body and on which one surface of the vehicle body panel is hooked, wherein a tension groove is formed in an inner circumferential surface of the grommet body to allow the grommet body to be elastically deformed inward when coupled to the vehicle body panel in a state in which the drain hose is fixedly inserted into the grommet body.

The tension groove may be formed to be recessed downward from an upper surface of the grommet body.

The tension groove may be formed to be recessed downward below a lower surface of the vehicle body panel.

An expanding portion of which a diameter increases in an upward direction is formed in an upper portion of the tension groove.

A second stopping part having a smaller diameter than the first stopping part may be formed below the first stopping part.

The second stopping part may be formed to be positioned at a level which is the same as or below a level of a lower end of the tension groove.

The diameter of the second stopping part may correspond to an inner surface of the vehicle body panel hooked on the first stopping part.

Each of the first stopping part and the second stopping part may have a hook structure.

A protruding part may be provided to protrude from a lower surface of an edge of the grommet body.

A separation distance between an inner wall of the tension groove and an outer wall of the drain hose may be smaller than a fixing distance of the first stopping part.

The separation distance may be greater than 1 mm.

The tension groove may be formed to be recessed upward from a lower surface of the grommet body.

The tension groove may be formed to be recessed upward above an upper surface of the vehicle body panel.

An inclined portion may be formed in each of an upper portion and a lower portion of the inner circumferential surface of the grommet body in which the through hole is formed.

### Advantageous Effects

According to one embodiment of the present invention, productivity can be improved by improving assemblability of a drain grommet to a vehicle body and preventing worker's dissatisfaction.

In addition, according to one embodiment of the present invention, since oil coating method used for improving assemblability of a vehicle body is not applied, an increase in cost due to the method can be reduced.

In addition, according to one embodiment of the present invention, since a drain grommet has a two-stage hook structure, a fixing force can be increased when the drain grommet is fixed to a drain hose.

### BRIEF DESCRIPTION OF THE DRAWINGS

FIG. 1 is a cross-sectional perspective view illustrating a structure in which a drain grommet and a drain hose are coupled to a vehicle body according to one embodiment of the present invention.

FIG. 2 is a cross-sectional view illustrating the structure in which the drain grommet and the drain hose are coupled to the vehicle body according to one embodiment of the present invention.

FIG. 3 is a cross-sectional view illustrating a structure in which a drain grommet and a drain hose are coupled to a vehicle body according to another embodiment of the present invention.

FIG. 4 is a cross-sectional perspective view illustrating a structure in which a drain grommet and a drain hose are coupled to a vehicle body according to still another embodiment of the present invention.

FIG. 5 is a cross-sectional view illustrating the structure in which the drain grommet and the drain hose are coupled to the vehicle body according to still another embodiment of the present invention.

### MODES OF THE INVENTION

Since the present invention may be modified in various ways and have numerous embodiments, specific embodiments will be illustrated in the accompanying drawings and described in the detailed description. However, this is not intended to limit the present invention to the specific embodiments, and it is to be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the inventive concept.

While terms such as “first” and “second” may be used to describe various components, such components are not limited by the above terms. These terms are used only to distinguish one component from another.

The terminology used herein is for the purpose of describing particular embodiments only and is not intended to limit the present invention. The singular forms are intended to include the plural forms, unless the context clearly indicates otherwise. In the present specification, it should be understood that the terms “comprise,” “comprising,” “include,” and/or “including” used herein specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but this may also mean that two or more components are indirectly connected through other components or are physically connected as well as electrically connected, or are one thing even referred to as different names according to positions or functions thereof.

Hereinafter, embodiments of a drain grommet according to the present invention will be described in detail with reference to the accompanying drawings, and when the embodiments are described with reference the accompanying drawings, components that are the same or correspond to each other will be denoted by the same reference numerals, and redundant description will be omitted,

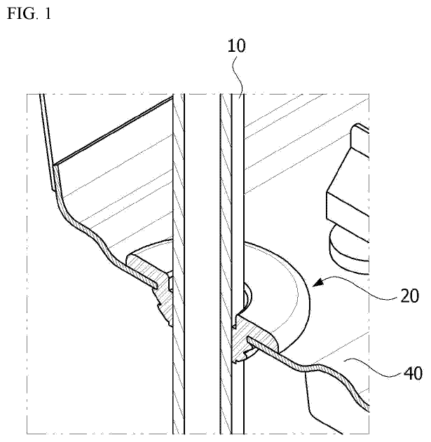

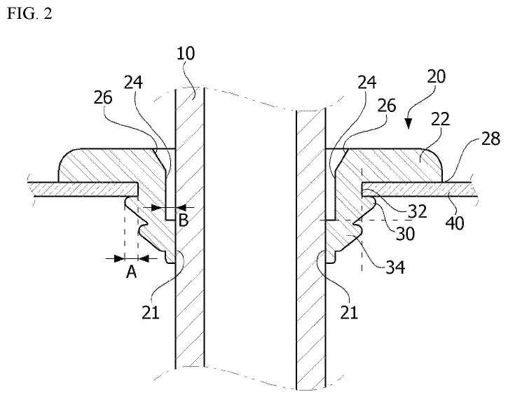

FIG. 1 is a cross-sectional perspective view illustrating a structure in which a drain grommet and a drain hose are coupled to a vehicle body according to one embodiment of the present invention, and FIG. 2 is a cross-sectional view illustrating the structure in which the drain grommet and the drain hose are coupled to the vehicle body according to one embodiment of the present invention.

According to the illustrated drawings, the drain grommet according to one embodiment of the present invention may include a grommet body 22 in which a through hole 21 is formed, wherein a drain hose 10 is inserted into the through hole 21, and a first stopping part 30 which is provided to protrude from an outer circumferential surface of the grommet body 22 and on which one surface of a vehicle body panel 40 is hooked, and a tension groove 24 may be formed in an inner circumferential surface of the grommet body 22 to allow the grommet body 22 to be elastically deformed inward when coupled to the vehicle body panel 40 in a state in which the drain hose 10 is fixedly inserted into the grommet body 22.

The drain grommet 20 has a structure which is assembled to the vehicle body panel 40 and through which the drain hose 10 passes. In the present invention, a structure for solving a difficulty in assembly of the drain grommet 20 occurring in a structure in which an outer diameter of the drain hose 10 and an inner diameter of the drain grommet 20 are the same will be provided.

The grommet body 22 has a hollow structure in which the through hole 21 is formed in a substantially center thereof and is coupled to the vehicle body panel 40 to serve to fix the drain hose 10. An outer diameter of the through hole 21 may be formed to be the same as the outer diameter of the drain hose 10 to fix the drain hose 10. In one embodiment, the grommet body 22 may have a circular cross-section for uniform distribution of a weight.

The tension groove 24 may be formed to be recessed downward from an upper surface of the grommet body 22 in the inner circumferential surface of the grommet body 22 in which the through hole 21 is formed. The tension groove 24 serves to provide a space in which the grommet body 22 may be elastically deformed inward when the grommet body 22 is coupled to the vehicle body panel 40 in a state in which the drain hose 10 is fixedly inserted into the grommet body 22.

More specifically, in a structure in which the outer diameter of the drain hose and an inner diameter of the grommet body 22 are the same, when the drain hose and the grommet body 22 are coupled to the vehicle body panel 40, the grommet body 22 is pressed by the vehicle body panel 40, and the vehicle body panel 40 is not caught in a catching groove 32 to cause a problem in difficulty of assembly. Accordingly, in the present invention, the tension groove 24 is formed to provide a space to allow elastic deformation inward when the grommet body 22 is pressed. The grommet body 22 is elastically deformed toward the tension groove 24 when coupled to the vehicle body panel 40, and is restored to an initial state when the vehicle body panel 40 moves over the first stopping part 30 so that the drain hose 10 is stably coupled to the vehicle body panel 40.

Meanwhile, the tension groove 24 may be formed to be recessed downward below a lower surface of the vehicle body panel 40 having a predetermined thickness. This is because, when the tension groove 24 is formed to be recessed only to a level above the lower surface of the vehicle body panel 40, a space in which the grommet body 22 is elastically deformed inward may not be sufficiently secured.

In addition, an expanding portion 26 of which a diameter increases in an upward direction may be formed in an upper portion of the tension groove 24. The expanding portion 26 is a portion formed to facilitate insertion of the drain hose 10.

A protruding part 28 may be provided to protrude from a lower surface of an edge of the grommet body 22. The protruding part 28 allows the grommet body 22 to be more stably fixed to the vehicle body panel 40 when the grommet body 22 is fixed to the vehicle body panel 40.

The grommet body 22 includes the first stopping part 30 for coupling with the vehicle body panel 40. The first stopping part 30 has a hook structure protruding outward, and the catching groove 32 which actually catches the vehicle body panel 40 is formed between the first stopping part 30 and the grommet body 22.

A second stopping part 34 having a smaller diameter than the first stopping part 30 may be provided below the first stopping part 30. The second stopping part 34 having a hook structure which is the same as that of the first stopping part 30 may have a two-stage hook structure with the first stopping part 30. When the second stopping part 36 is formed as described above, since a portion below the first stopping part 30 is not filled, the grommet body 22 can be more easily elastically deformed. In addition, since the second stopping part 36 has the two-stage hook structure with the first stopping part 30, a fixing force can be increased when the grommet body 22 is fixed to the drain hose 10.

The second stopping part 34 may be formed at a level which is the same as or below a level of a lower end of the tension groove 24. This is because, when the tension groove 24 is formed excessively deeply downward, the grommet body 22 may not be firmly coupled to the vehicle body panel 40. In addition, the diameter of the second stopping part 34 may correspond to an inner surface of the vehicle body panel hooked on the first stopping part 30. That is, the second stopping part 34 may be positioned vertically collinear with an end of the inner surface of the vehicle body panel 40. Meanwhile, a separation distance B between an inner wall of the tension groove 24 and an outer wall of the drain hose 10 may be smaller than a fixing distance A of the first stopping part 30. In this case, the fixing distance A is a length of a portion on which the vehicle body panel 40 is hooked on the first stopping part 30.

As described above, unstable coupling, which occurs when the separation distance B is not smaller than the fixing distance A, of the vehicle body panel 40 in a state in which the vehicle body panel 40 is coupled to the grommet body 22 can be prevented, and thus separation of the vehicle body panel 40 can be prevented when the drain grommet 20 moves. In one embodiment, the separation distance B between the inner wall of the tension groove 24 and the outer wall of the drain hose 10 may be greater than 1 mm. This is to prevent degradation of assemblability due to a hose repulsion force during insertion of the drain hose 10.

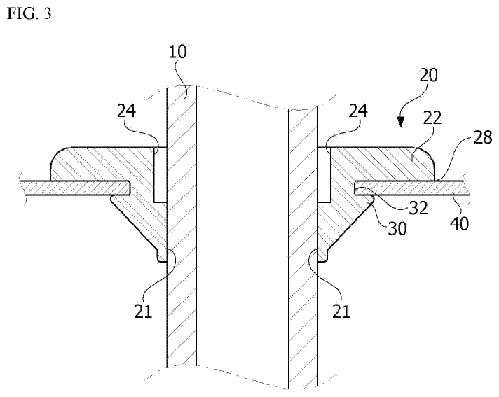

FIG. 3 is a cross-sectional view illustrating a structure in which a drain grommet and a drain hose are coupled to a vehicle body according to another embodiment of the present invention.

Referring to the drawing, in the present invention, in a tension groove 24 formed in a grommet body 22 in a drain grommet 20, an expanding portion 26 is not formed like the above-described embodiment but is formed in a hollow shape in a vertical direction.

In addition, in the present invention, a separate second stopping part 34 is not formed in a lower portion of the grommet body 22, and only a first stopping part 30 is formed. However, when the grommet body 22 is formed as described above, although elastic deformation of the grommet body 22 may be slightly limited, since the limitation may be overcome through a shape and a material of the grommet body 22, the grommet body 22 may be formed as described above.

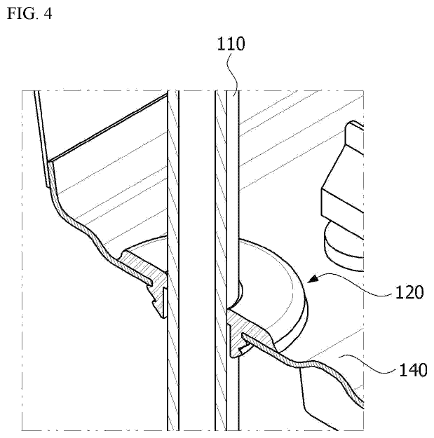

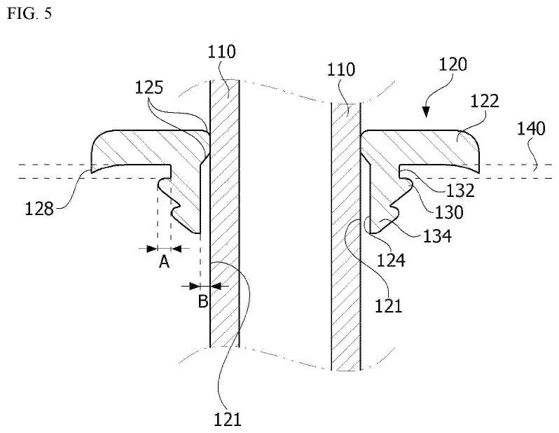

FIG. 4 is a cross-sectional perspective view illustrating a structure in which a drain grommet and a drain hose are coupled to a vehicle body according to still another embodiment of the present invention, and FIG. 5 is a cross-sectional view illustrating the structure in which the drain grommet and the drain hose are coupled to the vehicle body according to still another embodiment of the present invention. In the drawings, numbers in the hundreds are assigned to components the same as those of the above-described embodiments, and detailed descriptions thereof will be omitted for convenience.

Referring to FIGS. 4 and 5, in the present invention, unlike the above-described embodiments, a tension groove 124 may be formed in an inner circumferential surface of a grommet body 122 in which a through hole 121 so that the tension groove 124 is recessed upward from a lower surface of the grommet body 122. The tension groove 124 serves to provide a space in which the grommet body 122 may be elastically deformed inward when the grommet body 122 is coupled to a vehicle body panel 140 in a state in which a drain hose 110 is fixedly inserted into the grommet body 122.

Meanwhile, the tension groove 124 may be formed to be recessed upward above an upper surface of the vehicle body panel 140 having a predetermined thickness. This is because, when the tension groove 124 is formed to be recessed only to a level below the upper surface of the vehicle body panel 140, a space in which the grommet body 122 is elastically deformed inward may not be sufficiently secured.

In addition, inclined portions 125 may be formed in an upper portion and a lower portion of the inner circumferential surface of the grommet body 122 in which the through hole 121 is formed. The inclined portions 125 can facilitate insertion of the drain hose 110.

While the present invention has been described above with reference to specific embodiments, it may be understood by those skilled in the art that various modifications and changes of the present invention may be made within a range not departing from the spirit and scope of the present invention defined by the appended claims.

### REFERENCE NUMERALS

10: DRAIN HOSE
21: THROUGH HOLE
24: TENSION GROOVE
28: PROTRUDING PART
32: CATCHING GROOVE
40: VEHICLE BODY PANEL
110: DRAIN HOSE
121: THROUGH HOLE
124: TENSION GROOVE
128: PROTRUDING PART
132: CATCHING GROOVE
140: VEHICLE BODY PANEL

What is claimed is:

1. A drain grommet coupled to a vehicle body panel in a state in which a drain hose is fixedly inserted into the drain grommet, the drain grommet comprising:
a grommet body provided with a through hole into which the drain hose is inserted; and
a first stopping part which is provided to protrude from an outer circumferential surface of the grommet body and on which one surface of the vehicle body panel is hooked,
wherein a tension groove is formed in an inner circumferential surface of the grommet body to allow the grommet body to be elastically deformed inward when coupled to the vehicle body panel in a state in which the drain hose is fixedly inserted into the grommet body.

2. The drain grommet of claim 1, wherein the tension groove is formed to be recessed downward from an upper surface of the grommet body.

3. The drain grommet of claim 2, wherein the tension groove is formed to be recessed downward below a lower surface of the vehicle body panel.

4. The drain grommet of claim 1, wherein an expanding portion of which a diameter increases in an upward direction is formed in an upper portion of the tension groove.

5. The drain grommet of claim 1, wherein a second stopping part having a smaller diameter than the first stopping part is formed below the first stopping part.

6. The drain grommet of claim 5, wherein the second stopping part is formed to be positioned at a level which is the same as or below a level of a lower end of the tension groove.

7. The drain grommet of claim 5, wherein the diameter of the second stopping part corresponds to an inner surface of the vehicle body panel hooked on the first stopping part.

8. The drain grommet of claim 5, wherein each of the first stopping part and the second stopping part has a hook structure.

9. The drain grommet of claim 1, wherein a protruding part is provided to protrude from a lower surface of an edge of the grommet body.

10. The drain grommet of claim 1, wherein a separation distance between an inner wall of the tension groove and an outer wall of the drain hose is smaller than a fixing distance of the first stopping part.

11. The drain grommet of claim 1, wherein the separation distance is greater than 1 mm.

12. The drain grommet of claim 1, wherein the tension groove is formed to be recessed upward from a lower surface of the grommet body.

13. The drain grommet of claim 12, wherein the tension groove is formed to be recessed upward above an upper surface of the vehicle body panel.

14. The drain grommet of claim 1, wherein an inclined portion is formed in each of an upper portion and a lower portion of the inner circumferential surface of the grommet body in which the through hole is formed.
